(19) United States
(12) Patent Application Publication
(10) Pub. No.: US 2018/0165723 A1
(43) Pub. Date: Jun. 14, 2018

(54) MEASURING AND OPTIMIZING NATURAL LANGUAGE INTERACTIONS

(71) Applicant: Chatalytic, Inc., San Francisco, CA (US)

(72) Inventors: Timothy J. Wright, San Francisco, CA (US); Paul E. Brinich, San Francisco, CA (US)

(21) Appl. No.: 15/839,748

(22) Filed: Dec. 12, 2017

Related U.S. Application Data
(60) Provisional application No. 62/433,190, filed on Dec. 12, 2016.

(51) Int. Cl. G06Q 30/02; G06F 17/30; G06Q 10/06

(52) U.S. Cl. CPC G06Q 30/0281; G06Q 10/0635; G06F 17/30731

(57) ABSTRACT

Aspects of the invention generally relate to systems and methods for deriving structured data from natural language interactions and using it to measure and optimize the content and effectiveness of subsequent natural language interactions and other marketing activities.

### CROSS-REFERENCE TO RELATED APPLICATION(S)

This application claims the benefit of U.S. Provisional Patent Application No. 62/433,190 filed on Dec. 12, 2016, which is hereby incorporated by reference in its entirety.

### BACKGROUND

Providers of all types of goods and services interact through natural language interactions with existing or potential customers via a variety of different means which may include in-person conversations, voice telephony & IVR, voice command systems, email, SMS text messaging, on-site or in-app live chat, social platforms such as Twitter or Facebook, and mobile messaging apps. The interaction may be facilitated on either end by computer systems for workflow such as those provided by Oracle, Salesforce.com, Zendesk, Help Scout and others, or by telecoms, desktop, smartphone, or internet based applications such as email, phone, SMS, Facebook Messenger, Line, Kik, Skype, Whatsapp, Snapchat, WeChat, and others, or voice command systems such as Amazon Alexa, Google's Assistant, Apple's Siri, and others.

Such providers may have the need to perform analysis on such interactions for a variety of purposes, such as to measure the effectiveness of their natural language interactions with customers in achieving a desired goal such as a sale, or reducing customer defections. This information may be used to for a variety of purposes, which may include the performance management of teams of customer agents, providing information to different parts of their organization to help in product decision making, marketing, or to increase operational efficiency or the management of vendors.

Such providers may also have the need to extract useful structured data from the unstructured data in such natural language interactions for a variety of purposes—for example to use in other systems including ecommerce and order management systems, customer account management and admin systems, email, phone, SMS, smartphone push notifications, digital display or search advertising, television advertising, or business intelligence applications such as data warehouses, dashboards, digital marketing analytics, and other systems.

Such providers may wish to automate all or part of natural language interactions with customers. For example, a business may wish to automate parts or all of a natural language interaction with a customer to carry out more interactions at once or carry out interactions at lower cost.

Such providers may wish to identify particular categories of customer. For example, a business may wish to identify high value customers and prioritize engagement with them via human agents, or low value customers and prioritize automated interactions with them. Or a business may wish to identify “at-risk” customers who may be more likely to defect to a competitor or complain publicly about the company given their past and present behavior including their natural language interactions with the business so that they can take action for example to prevent defection.

Such providers may wish to optimize the effectiveness of their natural language interactions. For example, a business may wish to try different types of responses or sequence of responses to inbound messages, determine which works best to achieve a desired business goal such as increasing sales or reducing defection, cancelled subscriptions, cancelled orders or refund requests.

Unfortunately addressing these needs poses a number of challenges which may include that the data to carry out these tasks resides in multiple non-integrated systems, that the data is in different structures, that the data is generated via unscalable or unreliable methods such as customer surveys or manual inputs by human agents, or the periodic manual inspection of samples of natural language data from the interactions themselves by human managers or staff.

The need exists for a system that satisfies the above needs and overcomes the above problems, as well as one that provides additional benefits. Overall, the examples herein of some prior or related systems and any associated limitations are intended to be illustrative and not exclusive. Other limitations of existing or prior systems will become apparent to those of skill in the art upon reading the following Detailed Description.

### BRIEF DESCRIPTION OF THE DRAWINGS

The aspects, objects, features and advantages of the invention, as well as the invention itself, will be understood from the following Detailed Description when read together with the accompanying drawings which primarily illustrate the principles of the invention and the embodiments according to the invention. The drawings are not necessarily to scale. The drawings and the disclosed embodiments of the invention are exemplary only and not limiting to the invention.

FIG. 1 is a block diagram of a system for implementing aspects of the present invention.

FIG. 2 is an example of a category tag reporting chart that may be generated by the system of FIG. 1.

FIG. 3 is an example of a keyword reporting chart that may be generated by the System of FIG. 1.

FIG. 4 is an example of a conversation funnel reporting chart that may be generated by the System of FIG. 1.

FIG. 5 is an example of a referral score reporting chart that may be generated by the System of FIG. 1.

FIG. 6 is an example of a quality score reporting chart that may be generated by the System of FIG. 1.

### DETAILED DESCRIPTION

Providers of all types of goods and services want to understand and optimize the effectiveness of their natural language interactions with potential and current customers, and to use information from these interactions to increase the effectiveness of all their interactions with customers. The ultimate goal is to provide a better experience to customers that causes them to spend more, remain a customer for longer or share their positive opinion of the provider with other people.

In general, goods and service providers want to spend money on interactions wisely and make sure their interactions are efficient and effective. It can be expensive to hire, train and manage teams of human agents to carry out these interactions. It is also risky to use automated systems when such automated systems may provide a poor customer experience.

In general, goods and service providers seek to gain as much useful information about of their customers as possible. In part, this is so that they can disseminate this information throughout their organization and via the various systems supporting customer interactions, so that it can be used to inform business decisions and planning and increase the quality of their customer interactions via all customer touch points be they natural language based or otherwise.

In general, goods and service providers seek to reduce the amount of manual effort required to extract useful and actionable data from their natural language interactions with customers. It can be expensive, time consuming, and distracting to do this using manual and/or survey based methods and can lead to inaccurate or biased data.

Embodiments of the natural language processing system (“the system”) described herein generally relate to deriving structured data from unstructured natural language interactions between two or more entities, typically a provider of goods or services and a consumer, and using that data to understand characteristics of the interaction and the entities. In some embodiments, the provider of good or services (e.g., a merchant, retailer, etc.) acts as a user of the system. In some embodiments the customer, or other forms of end-user, acts as a user of the system. The characteristics may be the topics covered during the interaction or conversation, the progress and quality of the conversation, the category or segment of customer, as well as its outcome as it relates to defined goals. The system further uses the interaction characteristic data and other data to optimize interactions by making recommendations, providing automated responses or providing said data to external applications. The system thereby enhances the ability to identify effective and ineffective interaction trends between customers, potential customers, customer service agents, and other interaction participants.

The system described herein can provide one or more of the following benefits:
automate the process of generating structured data to describe natural language interactions including describing the topics of interest discussed, the degree of progress achieved toward a defined goal, the overall quality of the interaction and the factors contributing to overall quality. Prior approaches to solving these problems relied on manual review of natural language data, for example by customer service agents and manual data entry of resulting metadata, which often lead to inconsistent and unreliable results due to differing subjective interpretations of natural language interactions and subjective interpretation of tagging taxonomies used to characterize natural language interactions. In contrast the system, in some embodiments, carries out the generation of data in an automated and consistent manner across all the available data, thereby eliminating subjectivity, allowing data to be generated over a full history of natural language interactions (for example 100M customer service ticket transcripts may be processed in a matter of hours), at high volume in real time (for example customer service interactions at a rate of many thousands per hour may be processed in real time and the data acted upon in real time), and removes the need for costly of human effort to carry out this generation. Whereas prior automated approaches or semi-automated approaches to solving this problem may have relied on matching on exact keywords or phrases or metadata generated by an interaction platform, the system learns by examining patterns in the full natural language content of the interactions as well as metadata and other structured data sets which it associates with the unstructured natural language data;
to automate the process of combining structured data generated from natural language interactions with other sources of structured data and providing a mapping between the two sets of data. Prior approaches to solving these problems required human agents (for example customer service agents) to manually review structured data provided by other systems (such as eCommerce systems), and use that data to inform their interaction with another entity (for example to resolve a customer service issue regarding a reportedly late shipment the agent would look up the fulfillment state of a customer's order), and to combine that information with their subjective interpretation of the entity's enquiry (for example to record that the conversation topic or driver was “Late shipment enquiry>Order on time but customer not aware of shipping timeframe”). The system removes the need for a human agent to look up the structured data, eliminates subjectivity and inconsistency in the interpretation of that data, and the effort required to correctly combine and record the data with data derived from the natural language interaction;
to automate the process of generating structured data from natural language interactions and use that structured data to recommend or automate responses on a periodic of real time basis, or to facilitate targeted marketing. Prior approaches to solving these problems required the human agents to manually review natural language data and manually enter metadata (for example to create lists of customers or tickets to be responded to using a certain canned email message, then work with another system to initiate the email campaign). The system automatically analyzes the content of the natural language interaction to create actionable data on the entities (for example “at risk” customers who are likely to cancel their subscription), associates these entities with other structured data sets, categorizes interactions and entities, and provides entity level data to the systems used to respond to the entities or carry out targeted marketing to the entities;
to increase the efficiency of human customer support or sales agents in responding to customers either as part of a sales process or in resolving a customer enquiry; and/or. Prior approaches to solving these problems required human agents to manually review one or more natural language interactions, manually look up information on the entity, and manually combine these data for example to generate data describing the nature of the interaction. The system automates this and similar processes;
to facilitate reporting, automated responses or targeted marketing based off a customer's preferences, prior purchase behavior, level of satisfaction etc. without that customer having to complete a form, survey or other structured input. In accordance with aspects of the invention, useful information about consumers is derived from their natural language interactions with providers of goods and services enhanced where possible by combination with structured data sets such as purchase data, demographic data, marketing campaign data, registration data.

### Embodiments and Aspects of the System

Embodiments of the system generally will involve tracking and storing natural language data from interactions, processing those data and using the processed data to generate reporting, recommend or automate responses, and to provide structured data for use in other systems such as targeted marketing systems. As part of processing, additional data from structured sources may be combined with the derived data to enrich it.

In one embodiment, the system receives and processes (periodically or in real time) natural language based interaction data from a variety of sources and entities, processes that data to generate structured data at an individual customer and individual interaction level, and populates one or more data storage facilities (such as a relational database) with the derived information. The stored data may include the nature, content, progress and quality of their interactions as well as other useful information such as timestamp, duration, message interval, the raw natural language data, one or more customer IDs, the name or type of the system used to carry out the interaction, business user ID, product IDs, order IDs, shipment tracking IDs, and customer contact information. As described herein, the process of generating the stored data may include combining the natural language data with structured data available from other sources. Prior solutions required the use of manual review of natural language data followed by the manual entry of descriptive data into one or more computer systems. Other prior systems provided the ability to match on specific keywords and phrases, but this approach to deriving structured data can be inaccurate and prone to error, even at the topic level (and even less satisfactory for progress and conversation steps), given the high degree of variability in natural language. It is also very labor intensive, time consuming and costly. Prior solutions aimed at combining data from natural language interactions with data form structured sources typically relied on manually identifying some sort of user ID such as an email and carrying out an ad hoc analysis using a database or spreadsheet to perform aggregate analysis in the joined data sets. This is clearly inefficient and costly to repeat, and is inefficient when multiple possible identifiers such as order ID, email ID, subscription ID, mailing address, analytics ID may be required to achieve sufficiently high number of matched customers.

The combined structured data may represent standardized or categorized data associated with one or multiple customers of a system. For example, in the case of an eCommerce merchant, structured data characterizing the fulfilment status of a customer's most recent order may be combined with natural language topics data to see how many conversations with customers on the topic of “Where's my order” are associated with orders that are past due versus orders that are within the communicated shipping timeframe. In this way, the merchant may assess to what extent the volume of interactions on this topic may be reduced (and hence customer satisfaction and retention increased) by better informing the customer of the shipping timeframe versus ensuring better performance by fulfillment vendors, and then take action to address either issue (for example by improving communication to the customer on the merchant's website, or enforcing better compliance with SLAs with a fulfillment vendor), and measure the impact on volume of interactions, topic mix of interactions, and purchase behavior to determine how effective the action taken was in improving the customer experience and revenue. Such testing may also take the form of a strict A/B test wherein the system randomly assigns customers to one of two or more test groups and facilitates (e.g., by passing group IDs to the requisite communication systems such as email or web UI) a different treatment for each group (e.g., alternative communication on shipping timeframes for group A, same communication as before for group B, and no communication at all for group C). Prior solutions required human agents to derive the topic of the interaction from a manual review of the customer's natural language comments, and the state of the order from a manual review of an eCommerce, admin or order management system, and then combine them together (typically by manually entering the two bits of information into a computer system) to create a complete categorization of the driver for the interaction. Prior solutions required complex ad hoc reporting and manual association of data from different sources to determine the impact of any actions taken, and also did not support the implementation of strict A/B testing.

In another example, structured data characterizing the number of days remaining in a customer's subscription, the status of their subscription, and any promotional offers redeemed by the customer may be combined with natural language topics data and or natural language conversation step data to see how many conversations with customers on the topic “Cancel My Subscription” occur at different points in the subscription cycle, how many of these resulted in a cancellation, what agent intervention is effective in reducing the number of cancellations, whether promotional offers made by a human agents are effective in reducing cancellations, and what the increase in sales as a result of agent interactions may be.

In another example, the product or service SKU(s) the customer has purchased may be joined with natural language topic data and natural language user sentiment or satisfaction data to determine what products are leading to the most complaints about product quality, defective products or poor product fit. In this way, the merchant may assess whether they should consider making changes to their merchandizing mix, negotiate compensation or pricing terms with their vendors, or change the SKU being provided to their customer to one that may be a better fit for their needs. Finally, a customer's previous purchase history, derived cancelation risk, or web analytics data may be combined with conversational data in order to prioritize interaction with the customer. This way, the merchant can ensure they are responding to the most important customers in the most effective manner possible. It will be appreciated that various forms of structured data, characterizing different aspects of a customer (e.g., account status, order history, web analytics, etc.) may be used. As described herein, various entities such as merchants and advertisers can then take advantage of the generated information stored in one or more data stores of the system to generate reports and insights, respond more effectively to customers, and target marketing messages more effectively.

In another example, the combined natural language data and other structured data may be joined with one or more user IDs such as email, mobile advertising ID, and name and address. The system may use the joined data to generate targeted marketing messages via various marketing channels, such as email, mobile push notifications, SMS, display advertising, video advertising, audio advertising, and remarketing. For example, a consumer might express a preference for allergy free dog food in a conversation with a customer service agent. By processing the natural language data associated with the consumer interaction, as well as combining with structured data as described above, the system may as a result associate certain tags or keyword, such as “allergy free dog food” with an account or profile associated with the consumer. The system may then generate banner advertisements on one or more websites that target the consumer and advertise a new brand of allergy friendly dog treats.

### Reporting

In one aspect, the system derives useful structured data from natural language interactions. The system may, for example, perform steps such as analyzing unstructured natural language data, generating a structured taxonomy (such as a list of topics or steps, or a hierarchical taxonomy of topics) to map the natural language data to, and/or mapping the natural language data to pre-existing available sources of structured data. The system may generate the structured taxonomy using a combination of automation and user input, or just automation or just user input. For example, the system may use existing metadata provided by the provider's platform or the human agents using it, or by using clustering analyses or other algorithmic approaches. It may also present a taxonomy of topics or steps to one or more human users along with summary data showing the frequency of the suggested topics or steps, and any correlations between them. It may also present a set of exemplar natural language interactions for a given topic or step that the user may review to determine if they form a useful and logical group. The user may then make decisions on whether to include any such provided exemplar interactions, topics and steps, and input this feedback into the system. One goal of this feedback from the user may be in generating a taxonomy that is mutually exclusive and collectively exhaustive of all the topics of interest to an end client. Another goal may be in generating a taxonomy that includes an intuitive hierarchy, for example a set of parent topics each with a number of child topics. Another goal may be to generate a list of topics that the system will later have a higher probability of being able to assign reliably to the natural language interactions of the client in question. Another goal may be in assessing the quality of the metadata being generated by the systems or workflows being used prior to the implementation of the system, for example to set a benchmark for performance of the system. Another goal may be to provide a truth set of exemplar topics that may then be used in statistical analysis to classify natural language interactions or parts of interactions into topics or steps. The system may use the mapped data to determine topics of interest mentioned, progress made through a series of steps or toward resolving an issue or making a purchase, and the overall quality of the interaction. The structured data is stored and used to provide reporting, recommend or automate responses, or in external applications for example to carry out targeted marketing.

### Combining Data Sets to Identify Individual Customers

In yet another aspect the system utilizes data (both natural language interaction data as well as structured data) from different data sets to identify the same customer across multiple touch points (e.g., across different interactions with the same or different merchants). As described below, by identifying the same customer across different touch points, the system may generate a user profile for that customer that encompasses the information regarding that customer across the different touch points. The system may join across two or more data sets to achieve the desired combination. Data sets may include natural language interaction data from one or more sources, consumer purchase history data, digital analytics data, offline purchase data, data from marketing systems such as Customer Relationship Management or Helpdesk systems, and other sources. Data sets may be provided by one or more entities such as merchants or advertisers. Customers may be identified across these systems using identifiers which may include one or more of their name, phone number, email address, mailing address, order ID, product SKU(s) purchased, membership ID, subscription ID, analytics ID, session ID, or other unique ID assigned to them by the provider. The system may extract these identifiers from structured data or from unstructured natural language data in the systems. The combined data is then used for one or more purposes which may include to generate a useful output such as reporting on quality, topics, progress, recommending natural language responses, measuring the effectiveness of natural language interactions against a defined goal, or targeting messages.

### User Profile Data and Recommendations

In another aspect, the system provides structured user profile data and recommended responses in response to natural language inputs. Each user profile may, for example, characterize a particular customer. The system may, for example, perform steps such as analyzing unstructured natural language data, generating a structured taxonomy (such as a list of topics or steps, or a hierarchical taxonomy of topics) to map the natural language to, and/or mapping the natural language data to pre-existing available sources of structured data. The system may use the mapped data to determine characteristics of a particular customer, such as the purchase and interaction history of the customer and their lifetime value, and their known or likely preferences as relates to products, services, and interaction. The structured data and recommendations are stored and made available to human agents or automated systems via various interfaces. For example, based on the fact that a user has recently had a natural language interaction with the provider in which they shared that their dog had allergies, the system may recommend to a human agent that they inform the user of the allergen-free dog food option during that interaction or in a subsequent one. A targeted marketing system such as an email system may send a targeted email promoting an allergen-free supplement, or a display advertising remarketing system may place a banner ad for the same product on web pages the customer may visit.

### Measuring/Optimizing

In yet another aspect the system measures the effectiveness of natural language interactions and uses this measurement to optimize subsequent interactions. To measure natural language interaction effectiveness, the system may define one or more goals for interactions, and combine the natural language data with structured data that indicates whether the goal was achieved. For example, a provider may have a goal to reduce subscription cancellations. The system may analyze the natural language of an interaction between an agent and a customer and identify the steps “Customer provided negative product feedback”, “Agent thanked customer feedback”, “Agent informed user of upcoming price promotion”, and then provide an analysis of which agent responses lead to the lowest likelihood of a cancelled subscription following interactions where the customer provided negative product feedback. The effectiveness of different natural language responses (or no response at all) in achieving the desired goal is compared over a sufficiently large set of interactions so that the most effective may be identified and used in subsequent interactions. A sample set of interactions is deemed to be sufficiently large when it is statistically significant with respect to the total number of relevant interactions. The recommended responses may be delivered by a human or in an automated manner.

### Illustrative System Environments

Various examples of the system will now be described. The following description provides certain specific details for a thorough understanding and enabling description of these examples. One skilled in the relevant technology will understand, however, that the system may be practiced without many of these details. Likewise, one skilled in the relevant technology will also understand that the system may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the system. Indeed, certain terms may even be emphasized below; however, any terminology intended to be interpreted in any restricted manner will be overtly and specifically defined as such in this Detailed Description section

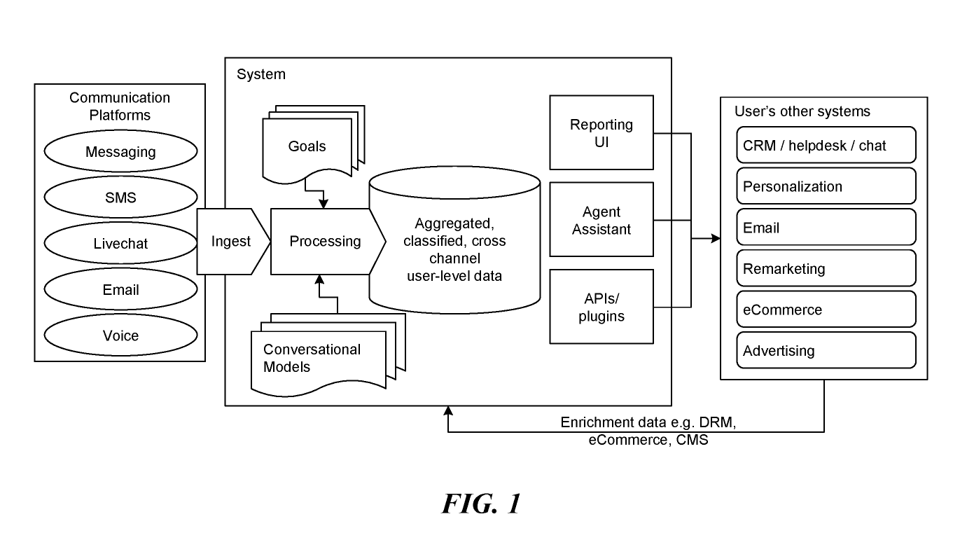

The system comprises several components as shown in FIG. 1 and described as follows. FIG. 1 and the following discussion provide a brief, general description of a suitable computing environment in which the system can be implemented. Although not required, aspects of the system are described in the general context of computer-executable instructions, such as routines executed by a general-purpose data processing device, e.g., a server computer, wireless device or personal computer. Those skilled in the relevant art will appreciate that aspects of the system can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” and the like are generally used interchangeably herein, and refer to any of the above devices and systems, as well as any data processor.

Aspects of the system can be embodied in a special purpose computer or data processor that is specifically programmed, configured, or constructed to perform one or more of the computer-executable instructions explained in detail herein. While aspects of the system, such as certain functions, are described as being performed exclusively on a single device, the system can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

### Data Ingest and Integrations

As illustrated in FIG. 1, natural language data from one or more Communication Platforms (e.g., messaging, SMS, live chat, email, etc.) is ingested via integrations of the platforms. Integrations can take the form of an API provided by the system, post of data to a shared folder, or the extraction of data from one of the Communication Platforms directly (for example using the Platform's API).

As further illustrated in FIG. 1, additional Enrichment Data may be ingested by the system from other computer systems. Other systems may include digital analytics systems such as Google Analytics and Omniture. Other systems may include eCommerce systems such as Magento and Shopify. Other systems may further include Content Management Systems (CMSs) such as Drupal, and Customer Relationship Management systems (CRMs) such as Salesforce.

The system normalizes the Natural Language data and Enrichment data into a common structure to allow for subsequent processing. For example, different platforms may name the same pieces of metadata relating to a conversation differently, such as the name of the human agent may be “agentName” in one platform, but “AgentID” in another, and the system will recognize that they are the same pieces of metadata and process and store them appropriately. In another example, different platforms may structure an exchange of comments differently (in one platform the text and user IDs may appear in a single string stored in a single database field (such as “User1234, 10:26 am, I'd like to check the status of my recent order, AgentABC, 10:27 am, certainly sir I'd be happy to check that for you . . . etc.”) whereas in another they may be broken out into separate database fields with one entry for each including a comment field, such as “I'd like to check the status of my recent order”, a corresponding user ID such as “User1234” and timestamp such as “10:26 am” in separate database fields, and the system will recognize the pieces of data and store them in a common structure. As part of the data ingestion, the system may generate text transcripts from ingested audio data.

Prior to processing ingested data, a user may configure the system to comprehend one or more Goals for their natural language interactions. For example, the user may set the goal “Customer provides order ID” and specify that the list of valid order IDs is available via enrichment data from the eCommerce system. As illustrated in FIG. 1, for example, Goals may be configured by a user of the system in advance of data ingest, and may be used for processing the ingest data.

### Data Joining and User IDs

To facilitate ingesting and processing data, the system may assign a system-level unique user ID to each unique user or apparently unique user. The system may use these unique user IDs to, for example, track different natural language interactions from one or more sources that are with the same user or customer. In some embodiments, the system identifies when the same customer is part of different interactions. In some embodiments, the system de-duplicates users across natural language interactions for a particular customer. To identify the same user in different instances, the system may, for example, use user email addresses from eCommerce and CRM systems. In another example, the system may use platform user identifiers from systems such as, web analytics or smartphone messaging applications. That is, for example, matching of sufficiently similar email addresses or platform identifiers across different interactions may be associated with the same user.

In some embodiments, the system joins data from different sources together. There are a number of ways the system may do this. In one example, the system uses digital analytics data, in another example the system uses User data from eCommerce or CRM systems. As described herein, the joining of data from different sources facilitates further analysis of customer interactions and optimizations. For example, the product or service SKU(s) that customers have purchased may be joined with natural language topic data to determine what products are leading to the most complaints about product quality, defective products, or poor product fit. In this way, a merchant user of the system may assess whether they should consider making changes to their merchandizing mix, negotiate compensation or pricing terms with their vendors, or change the SKU being provided to their customer to one that may be a better fit for their needs. In another example, a web analytics session ID and/or a URL may be used to associate a customer's web browsing behavior prior to carrying out a chat interaction with a human agent, in order to determine how many interactions are associated with user having trouble checking out on a merchant's website.

### Processing Pipeline

As illustrated in FIG. 1, the system processes the ingested Natural Language Data (ingested, for example, from one or more Communication Platforms), Enrichment Data and Goals to generate structured data. This processing can happen either synchronously with the data being supplied or asynchronously on a scheduled interval. In some embodiments, the system may process all or part of the data in real time or with batch processing. Once data has been processed, for example through the Processing step illustrated in FIG. 1, the data is described as Processed Data and is stored by the system for further use. As described herein, the stored Processed Data enables the system to analyze customer interactions, generate reports, etc.

### Models

As illustrated in FIG. 1, the system may generate structured data from the natural language data by applying one or more Conversational Models to the unstructured data. As described below, Conversational Models can be generated by (1) generating an initial taxonomy and truth set, (2) creating a model, (3) interpreting output scores, (4) testing and refining the model, and (5) approving the model taxonomy. However, other approaches to generating a Conversational Model may be used. In addition, each step may be done manually or in an automated fashion.

Step 1: Initial Taxonomy and Truth Set generation

An initial Taxonomy and Truth Set may be created by manually or otherwise reliably categorizing and tagging a sample set of natural language items (e.g., conversations or fragments of conversations) with metadata tags describing all or parts of each item. The resultant list of tags comprises the initial Taxonomy. The Taxonomy may include tags for topics, steps, sentiment, quality or other types of tags that are descriptive of the natural language items. For example, an item or parts of an item may be tagged with one or more Category Tags supported by the system, which represent which topics, issues, products or services were discussed during parts or the entirety of an interaction. In another example, parts of an interaction may be tagged with Step Tags to identify what step in a process that part of the interaction represents. For example, as described herein, a Step Tag may represent a typical phase that occurs during an order process (e.g., a customer asking about the price or availability of an item). Category Tags and Step Tags may be generated from Enrichment Data ingested by the system. In one example, data from an eCommerce system's product catalog may be used to generate a list of product related Category Tags. In another example, items may be tagged with sentiment buckets such as positive, neutral or negative sentiment.

The process of creating the truth set and the metadata tags may be carried out by a human operator or an automated system, or by a human operator assisted by an automated system (for example to select a random a sample of interactions, or to make suggestions as to what tags to apply). The system may also make use of any existing metadata generated by the platform or human operators using the platform when identifying a set of candidate items for a particular topic or step tag.

In one embodiment, the system provides a user interface to the human operator that allows the operator to search and filter on item metadata (for example the email subject line). In another embodiment, the user interface allows a user to sort, filter and carry out keyword search, specifically within the natural language text generated by the Target user (e.g. customer) text or the natural language text generated by the system User (e.g. customer service agent), or both. This can be helpful in the case where customer service agents use distinct key canned phrases or common phrases when responding to certain topics of inbound requests from customers and sorting/filtering or searching for this text may be used to find exemplar tickets for these topics.

In another embodiment, the system provides access to the full transcript of the items for review in a UI. In another embodiment, the system provides links to the full transcript within the conversational platform UI by including a hyper link to the appropriate transcript within the system UI.

In another embodiment of the system, the truth sets may be comprised of data sourced from multiple providers, for example, the system may determine that better performance in assigning tags for topics, steps, quality, or sentiment may be achieved by pooling natural language items across a number of merchants.

In another embodiment of the system, the truth sets may be comprised of data identified partially or wholly using structured data form other systems that the system has associated with the natural language interactions. For example, to generate a truth set for customer service tickets that include the topic “Where is my Order>Undeliverable”, the system may generate a set of tickets where it is known that the topic is “Where is my Order” and it is known that the most recent order for the customer at the time of ticket creation had order status “Undeliverable.” In another example, to generate a truth set for customer service tickets from Wedding Guests regarding Surprise Gifts, the system may generate a set of tickets where it is known that the topic is Surprise Gifts, and the user submitting the ticket is a Wedding Guest. The benefit of this embodiment of the system over prior solutions to these problems is that the interactions may be identified at scale and automatically without the need for review by a human to validate the category.

### Step 2: Model Creation

A randomly selected subset of the Truth Set data (referred to as the Seed Set) is used to generate one or more statistical or neural network based Conversational Models. For example, a statistical model may be created in which Category Tags in the truth set are correlated with the appearance of certain keywords or phrases in the corresponding natural language data with a weight assigned to each keyword or phrase. For example, the system may see that 100% of all conversations that include the word “cancel” and 50% of conversations that include the word “dissatisfied” have been tagged with the topic tag “Cancel my subscription”, and accordingly weight the word “cancel” higher than the word “dissatisfied” when deciding if a conversation should be tagged with the “Cancel my subscription” tag. In another example, the system may see that a particular phrase such as “Where is my order” is in 50% of all the conversations that have been tagged with the topic “Order Status” while only occurring in 10% of all other conversations. The system may then choose to weight a conversation with the “Where is my order” phrase higher for the “Order Status” topic than other topics. The model may use any number of statistical or other “machine learning” techniques (such as neural networks) in order to apply itself to a broader data set. In one embodiment, the application of the model to a given item results in the generation of a set of scores, each score corresponding to a different topic. In some embodiments, the system may generate different Truth Sets for different Communication Platforms. Different Truth Sets may be used, for example, to accommodate the use of different patterns of natural language in different channels (e.g., conversations patterns found in email as compared to SMS messages). By generating different Truth Sets for different Communication Platforms, the system is able to provide greater model accuracy across different Communication Platforms. For example, in the SMS platform abbreviations or emoji may have greater weight than in the voice platform. As described herein, the remaining Truth Set, referred to as the Test Set, is retained for use in Refinement.

### Step 3: Score Interpretation

In embodiments where multiple per-tag scores are generated for a given item, the system may use one of several methods to select which tags to apply. In one such embodiment, the highest score or scores may be selected. In some embodiments, the separation of the scores may be used as criteria, so that a tag may only be applied if its score is greater than the next highest score by some threshold value. In another example, a separate threshold (minimum score) may be determined for each tag. In another example, more than one tag's score may qualify based on the rules to determine qualification, and a secondary processing step may be carried out to determine which of the qualifying tags to apply. In another example, the secondary processing step may include the application of rules that prevent certain topics from appearing together (for example, very similar topics such as “Refund>Damaged Goods”, and “Refund>Wrong items received” may both score very highly for the same item even though only one of them can ever be present according to the items in the Truth Set; accordingly, a rule may be defined such that only the highest scoring of these may be applied). In another example, the relative frequency of topics in a random selection of truth set items may be used to rank order topics that have met their respective qualifying thresholds, and a maximum number of topics per conversation may be set so that only the top N most frequent of the qualifying topics is applied. For example, if the topic Cancel Subscription, Refund and Confirm Order Status all qualify by having scores above their respective qualifying thresholds, but it is known from the random Truth Set sample that these topics occur with a frequency of 40%, 20% and 10% respectively, and a maximum of 2 topics is permitted, then only Cancel Subscription and Refund topics will be applied as tags and Confirm Order Status will be ignored. In another example, the Truth Set sample may be used to generate a number of frequent topic combinations (topics which are observed to appear together frequently), and the frequency of these combinations may be used to determine what combinations of tags to include from the qualified set. For example, the pairs Refund & Cancel Subscription, Cancel Subscription & Confirm Order Status and Refund & Confirm Order Status may occur with the frequency 10%, 2% and 1% so that if all three constituent topics qualify by having scores above their respective qualifying thresholds only the pair Refund & Cancel Subscription will be applied. These are just some examples of rules that may be applied by the system to select tags to apply based on a set of output scores.

### Step 4: Model Testing and Refinement

At a testing and refinement step, the system applies the created models to the Test Set and generates tags. The generated tags are then compared to the actual topics and steps for that Set and performance data is generated. In one example, the performance data may include one or more of Coverage (the percentage of items that are assigned at least one tag), False positive rate (the number of times a given tag is applied incorrectly divided by the total number of times the tag is applied), False negative rate (the number of times a given tag is not applied where it should have been applied divided by the total number of instances where it should have been applied), and the Match rate (the number of times a given topic or step was applied correctly divided by the total number of times it was applied). In one example, the performance data is computed in aggregate over all the items in the Test Set. In another example, it is computed on a per tag basis. The generation of this performance data may be carried out by a human, or a human with the assistance from the system, or in a fully automated manner by the system.

Based on the performance data, the system refines the created models. Refinement may be achieved in one or more ways. For example, in some embodiments the system provides an operator with a report showing the model generated tags, the Test Set tags and the raw natural language data for the Test Set items. The operator then identifies areas where tagging output from the model is inaccurate and potential segments of natural language that may be leading to poor performance, or that could lead to better performance if they were better accounted for by the model. The operator then inputs changes to the model into the system. For example, the operator may determine that a certain keyword should have a lower weight in determining the application of a particular tag, or that all items containing a certain phrase should be excluded form a certain topic tag. In another example, the system displays to an operator those Truth Set items that are the most significant in causing the incorrectly categorized tickets and the Operator may remove these items from the Truth Set. In another example, the system displays poor performing topics and steps and the operator finds additional examples of exemplar items to add to the Truth Set to improve performance. In another example, the system may present a set of potential items for the Truth Set that may improve model performance, and the operator may review and select which of these to add to the Truth Set. In another example, the Provider may review lists of classified items in Reporting output from the system and provide a list of misclassified items to the Operator who may then add these to the appropriate categories in the Truth Set. In another example, the Provider may add these misclassified examples in a self-serve manner without requiring assistance from the Operator. As a further example, in some embodiments the system automatically identifies where tagging output from the model is inaccurate and automatically updates the weightings in the model.

### Step 5: Approval of Taxonomy and Ongoing Maintenance of Models

The process described above may be repeated one or more times during an initial set up period with or without feedback provided by a user (for example a business owner) until output tagging at a sufficient level of performance is achieved to meet the provider's needs for reporting, recommending or automating responses or marketing messages. The sufficiency of performance is determined by agreement between the Provider and Operator. As part of this set up, changes may be made to remove poor performing topics from the Taxonomy, or add new ones that are discovered until a sufficiently performant and complete taxonomy of output structured data is achieved.

In some embodiments, one or more of the above-described steps are repeated until a sufficient level of accuracy has been achieved. Some or all of the same steps may be repeated periodically over time to improve accuracy and to accommodate changes in the patterns of natural language interactions between a provider and its customers (for example when new products or policies are introduced).

In addition, the system will periodically monitor the performance of the existing classification process. If performance is below the desired threshold, new topics to add to the Taxonomy may be recommended by the system. For example, if there is a new product offering such as a product being sold via a retail partner (such as Walmart, Target, etc.) as opposed to directly through the Providers website, the System may identify that a large number of conversations are being identified with the word “Walmart” and thereby recommend the addition of a “Product>Walmart” topic to the taxonomy. The recommendation may or may not be reviewed by the Operator before being added to the taxonomy.

### Keywords and Phrases, Tone of Voice

In some embodiments, the system generates additional structured data by identifying, counting the frequency, and recording the relative and absolute position of keywords and key phrases in the natural language data. In some embodiments, the system generates additional structured data by analyzing the patterns pitch, tone, and speed of spoken words in audio recordings (for example to identify an irate, depressed, or very happy customer). Structured data generated in this way may be used in its raw form or as an input into one or more conversational models, used, for example, during Processing (as illustrated in FIG. 1). For example, the conversation model for a Negative Product Feedback topic may incorporate the fact that conversations with this topic often include negative sentiment keywords or in the case of voice interactions, pitch and tone indicating unhappiness or dissatisfaction or frustration.

### Structured Elements of Natural Language Interactions

In some embodiments, the system can be configured to recognize certain elements of natural language interactions that may be known to occur regularly and that may be useful source items for certain Conversational Models. For example, the subject line of emails may be a good place to look for the initial topic of a conversation. As a further example, when live chats relating to subscription cancellations contain a canned prompt by an agent requesting the customer's reason for wanting to cancel their subscription, the first customer comment immediately following that canned prompt may be a strong source for the cancellation reason. In these examples and in others, specific models may be created to process these elements. For example, in the case of the cancellation reason prompt, a series of models may be created to create tags for each cancellation reason, where the truth set for each model comprises a set of items that are all users first responses to the canned prompt that are all exemplars of a certain cancellation reason, and the data to be processed comprises only the users first responses to the canned prompt. Isolating the data to be processed and the truth set items in this way may lead to better tagging performance.

### Composite Topics

In some embodiments, the system generates meta tags by looking for combinations of topic, step and other tags to generate derived meta tags. For example, the system may include models for Product Feedback, Cancel Subscription, and Product Durability. Then when the two tags Product Feedback and Product Durability are present, the system generates the meta tag “Cancel Subscription>Durability”, but when the Product Durability tag is present without the Cancel Subscription tag, the system generates the meta tag “Product Feedback>Durability”.

In another example, the system separates the natural language text generated by the User (e.g. customer service agent) from that generated by the Target User (e.g. customer), and processes each separately to generate tags, using separate truth sets and separate models trained from these truth sets. This can be helpful in the case where customer service agents use very similar language in responding to two or more different inbound requests from customers (for example when canned closing or opening messages are included) and the signal from these canned messages leads to all conversations include them being tagged with the same (set of) topic(s).

In another example, the system carries out two passes, the first to classify into a parent topic and the second to classify into respective child topics for the assigned parent topic.

In another example, the system combines data from analysis of the natural language with data from one or more sources to create a single topic tag, for example by associating the topic tag “Where's my order” from a customer's recent conversation with the fulfillment status of their most recent order to create the composite tag “Where's my order>In timeframe, en route to customer.” Prior solutions to this problem involved agents subjectively assessing the customer type and combining that assessment with an order status from another system to create a composite tag, and maintaining a very lengthy taxonomy of composite topics with all the resultant combinations of topic and order status. Such lengthy taxonomies are time consuming to create and manage and not intuitive to use and apply for agents carrying out interactions with customers, which increases the risk of subjectivity, inconsistency and low coverage of topic data. The system eliminates the subjectivity by taking an algorithmic approach to categorizing topics and associating existing structured data in an automated manner. It also eliminates the need for the creation and maintenance of complex taxonomies and the need to instruct human agents in their use.

In another example, the system combines data from analysis of the natural language with data from one or more sources to create a single topic tag, for example by associating the topic tag “Surprise gift” from a customer's recent conversation with the customer type “Wedding Guest” to create the composite tag “Wedding Guest>Surprise Gift”. Prior solutions to this problem involved agents looking up (where possible) or subjectively assessing the customer type and combining that assessment with a subjective assessment of the topic of enquiry to create a composite tag, and maintaining a very lengthy taxonomy of composite topics with all the resultant combinations of customer type and topic of enquiry. Such lengthy taxonomies are time consuming to create and manage and not intuitive to use and apply for agents carrying out interactions with customers, which increases the risk of subjectivity, inconsistency and low coverage of topic data. The system eliminates the subjectivity by taking an algorithmic approach to categorizing topics and associating existing structured data in an automated manner. It also eliminates the need for the creation and maintenance of complex taxonomies and the need to instruct human agents in their use.

### Data Storage

The Processed Data includes structured data (tag, keyword and key phrase data), the extracted features used by the Conversational Models, the scores generated by the Conversational Models, the Enrichment Data, the timestamps and user IDs associated with all the processed interactions, the Conversational Models, and the raw unstructured natural language data (in its original form whether audio or text, as well as the text transcripts of any audio data). The Processed Data is stored both in a file system and in a data store that allows for use in other application. Prior solutions to this problem did not create a unified system for storing both natural language derived structured data and associated structured data from other sources and hence made it very difficult to make use of any data derived from natural language interactions in other applications such as targeted marketing.

### Data Access and Reporting

### Reporting UI

A User can access processed data via a GUI (graphical user interface), or a natural language user interface (e.g., using one or more of the Platforms described above).

The GUI may include visualizations of data in time series plots, frequency distributions, and the ability to apply segments and view comparisons of different parts of the data set that may be of interest to the User.

Elements of the UI may be included as plugins within other systems (see Plugins below).

### Agent Assistant

A User (for example a human customer service agent) or groups of Users can access user-level data for assistance in the course of responding to a customer in the Agent Assistant interface.

### API

A User or a computer automated system can access processed data via the system's API (Application Programming Interface). For example, Users may wish to use the API to include the structured data in other automated systems as described above.

### Plugins

For ease of use of the system may include configurable plugins for various 3rd party systems. For example, plugins for various natural language interaction platforms such as Zendesk, Salesforce, Oracle, etc. may be included.

### Real Time Access

Any part of the system may operate in real time depending on the needs of the customer and the data sources involved.

### Features

### Segmentation

The User can apply various segment criteria to access and view subsets of the processed data, and compare different subsets. Segment criteria can be generated from any of the Processed data. For example the user can view segments specified according to Category Tag, Conversation Step Tag, User Sentiment bucket, Conversation Quality Score, Customer ID, CRM-based Customer Segment, eCommerce Product ID or product type, Issue Type, Agent name or group, Channel, geography, Cohort (a “Cohort” may be some combination of customer acquisition date an some other criteria such as geography, marketing channel or service plan), or other metadata associated with the user or the interaction, or some combination of these metadata. Such segments may be applied to any of the below reporting types.

### Canned Message Tagging and Reporting

Businesses using teams of agents to interact with consumers may wish to provide canned messages, or scripts, to their agents to make it faster for them to respond to users, but may also want to make sure the agents are personalizing these messages so they don't give the impression to the consumer that they are interacting with an automated system. Accordingly, the system provides Canned Message Tags as part of the Processed Data, and uses these to generate reporting that shows the frequency with which canned messages are being used in interactions without personalization or with varying degrees of partial personalization. The same data may be available via the API.

The system may generate the Canned Message Tags in various ways. In one embodiment, for example, each Canned Message Tag is generated by the application of a corresponding Conversational Model. In another embodiment, the canned message tag is generated by a looking for an exact or partial match on a set of canned message texts provided by the client.

### Category Tags and Reporting

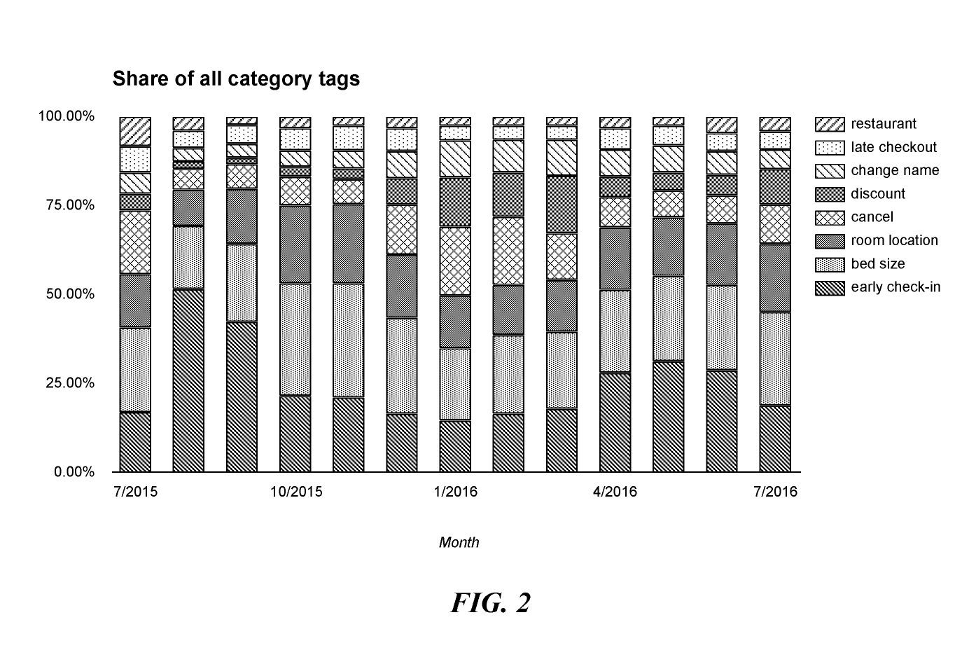

A User may wish to understand the frequency of certain topics in a set of interactions, and to see how the frequency and relative frequency of topics changes over time. For example, a User may wish to know how much a particular product or service is being mentioned. There may be multiple different topics discussed in a single conversation. The System provides Category Tags as part of the Processed Data and uses these to generate reporting. FIG. 2, for example, illustrates an example report. The same data may be available via the API.

The system may generate the Category Tags in various ways. In one example of this, each Category Tag may be generated by the application of a corresponding Conversational Model.

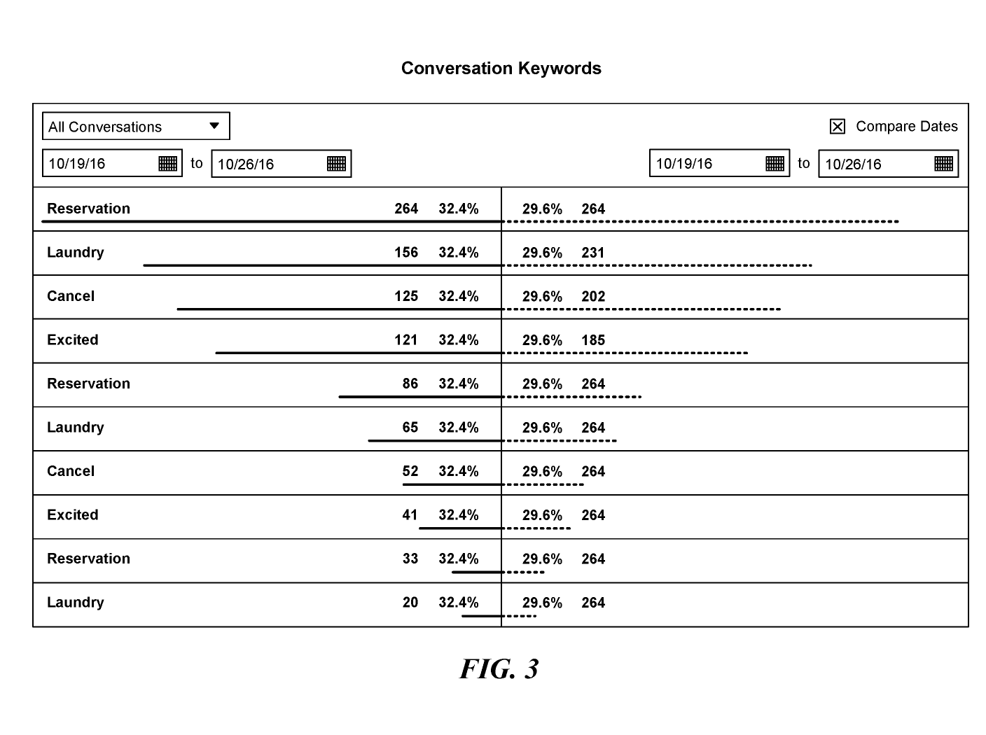

The System provides reporting so that the user may examine the frequency of different keywords or phrases and compare these for different time periods to further understand what may be driving an increase in the volume of a particular Category Tag over time. FIG. 3, for example, illustrates an example report.

### Conversational Funnel Tagging and Reporting

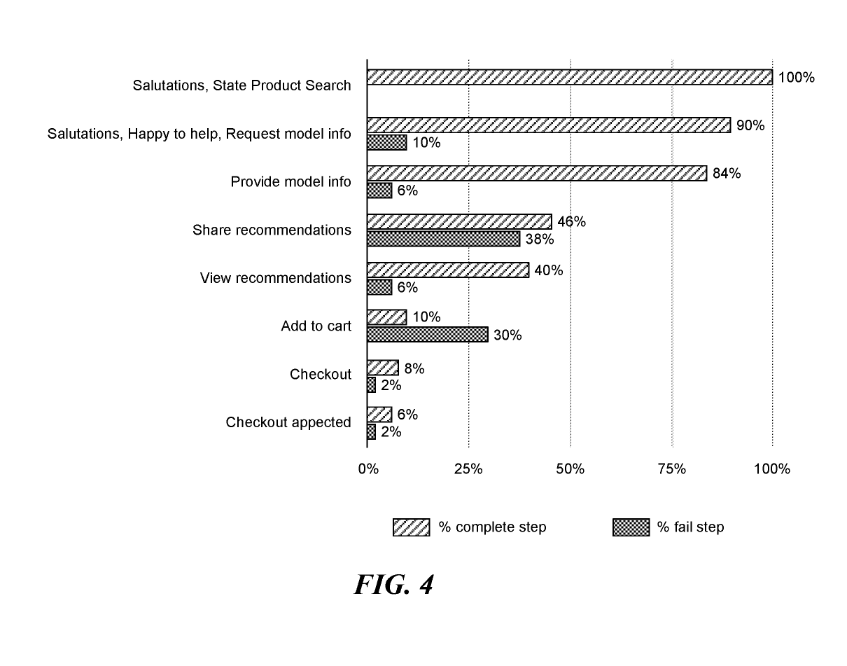

A User may wish to understand the effectiveness of their natural language interactions in moving through a defined process toward a goal. In one example, a business may wish to understand how far along the path to purchase they are getting with customers in one or more Platforms. The system provides Conversation Funnel reporting, such as illustrated in FIG. 4. The system reports on the number of conversations that have reached up to a given step, regardless if they reach that step once, or more than once. The system can generate reports on the number of times a given step is reached in a given conversation. The same data may be available via the API.

A User may wish to understand if a number of desired steps are taken during their natural language interactions, regardless of the order in which they are taken. In one example, a business may wish to understand for those interactions relating to returning defective merchandize whether customer service agents are capturing an order number, apologizing to a customer, thanking a customer for their patience, providing an estimated time of arrival for a replacement product, and asking the customer if there is anything else they can help with, regardless of the order these steps are being done during an interaction. The system reports on the number of conversations that have included a given step, regardless if they reach that step once, or more than once. The System can generate reports on the number of times a given step is reached in a given conversation. The same data may be available via the API.

The system may generate the Conversation Step Tags in various ways. In one example of this, each Conversation Step Tag may be generated by the application of a corresponding Conversational Model.

### In-Conversation Conversion Tagging and Reporting

In cases where a goal may be achieved during the course of an interaction, a User may wish to understand how many interactions reached that goal and the conversion rate for that goal. For example, if a customer can make a purchase during an interaction, then a User can define within the system a corresponding goal. As illustrated in FIG. 4, the system can then generate a report characterizing the number of interactions that satisfied that goal (e.g., the percentage of interactions that reached a “checkout accepted” step, and the percentage of interactions that completed the “checkout accepted” step).

Phases of an interaction conversation or conversation may be associated with a Conversion Tag. The system may generate the Conversion Tag in various ways. In one example of this, each Conversion Tag may be generated by the application of a corresponding Conversational Model

### Post and Pre-Interaction Conversions, Affected Spend Measurement and Reporting

In cases where a goal is achieved outside of the Conversational Channel, the system can tie the achievement of those goals by a user to interactions including the same user. This can be achieved, for example, using the Joins step in processing described above. As described herein, the system can then include this information in the Processed Data and report on it in various ways.

One way the system can report on this information is to show to a business user the total lifetime value of all customers who have interacted with the business via Conversational Platforms. Another way is to report on the affected sales that took place within a specified look-back window (e.g., number of hours, days, weeks etc.) following an interaction via a Conversational Platform. Another way is to report on the affected sales that took place within a specified look-forward window (e.g., number of hours, days, weeks etc.) before an interaction via a Conversational Platform. Another way is to include information describing the quantity, the dollar value and product or service assortment of sales. Another way is to include all measured steps including the in-conversation steps and the associated post-conversation steps. Another way is to define cohorts of users based on their user profile, nature and time of their natural language interactions, and track the purchase behavior of those cohorts over time and relative to one another.

### Channel Impact Measurement

A User may wish to measure the relative effectiveness of two or more Conversational Platforms as defined by the impact on a certain goal. In one example, this may be to make resourcing or staffing decisions by channel. In another example, a business may use this information to decide which Conversational Platforms yield the best results for a particular segment of consumers.

The System provides reporting that shows the relative effectiveness according to the desired business goal. In one example, this may be in-conversation conversions. In another it may be affected customer lifetime value, in another example it may be affected sales.

### Referral Source Measurement

A user may wish to measure the relative effectiveness of Conversational Platforms in achieving a certain goal for customers arriving to the Channel via different referral paths, for example from different websites.

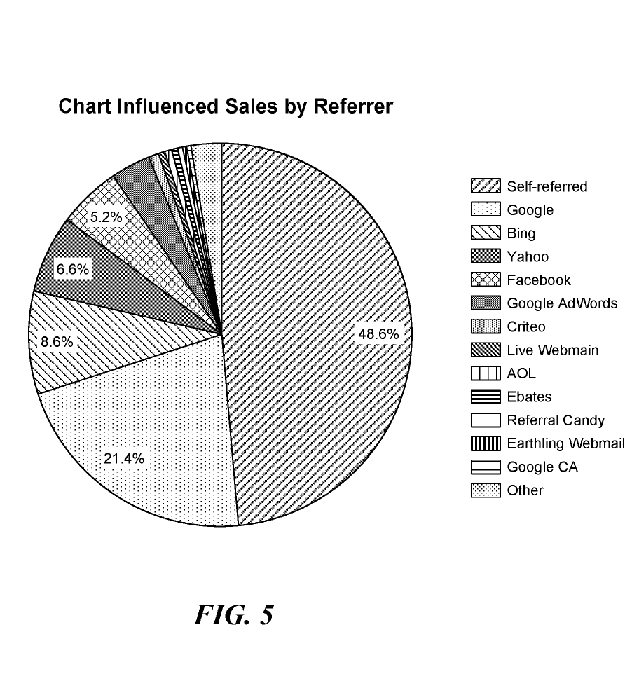

The system provides reporting that shows the goal metric split by referral channel. There are various ways the system may report on this. For example, the metric may be affected sales or the % of all affected sales. FIG. 5 illustrates an example referral source report.

### Quality Score

To reduce the number of metrics required to track and communicate performance, or to set more simple performance goals for achievement, or to create a score for every interaction such that the interactions then be segmented into smaller subdivisions (for example by agent and then by topic) while retaining sufficiently significant number of conversations (to allow for comparisons and conclusions to be drawn based on the data), a user may want to use a single number, or Quality Score, to describe the quality of an interaction.

One way this number may be generated is using a Quality Score Conversation Model, with the output tag being a number indicating the quality of the interaction. The Quality Score assigned to each item in the Truth Set for that model may be a related to the keywords and phrases used in the item, whether there was an in-conversation conversion or one within some specified lookback period after the conversation, or the results of post conversation satisfaction surveys. For example, an item in which a user completes a purchase may be given a high Quality Score, whereas an item in which a user does not receive a clear answer to a customer service question may be given a low Quality Score. As a further example, an item that feature tags associated with a negative user experience may be given a low Quality Score.

Another way Quality Score may be generated is by training a model using a sample set of interactions that have associated post interaction survey or net promotor score (“NPS”) structured data. In this example, high NPS interactions (for example) are added to a High Quality Score Truth Set, and low NPS interactions are added to a Low Quality Score Truth Set, two models are trained and applied to natural language interactions and the resulting sores are used to compute a single Quality Score. More than two truth sets may be used (for example High, Medium and Low).

Another way Quality Score may be generated is by taking a weighted average of two or more relevant metrics such as goal conversion, response time, conversation depth, most advanced conversation step reached, user sentiment, user NPS score, or Modelled Quality Score as described above. In this example, the weights may be generated by a process similar to the Truth set, Model creation, Testing and Refinement process described above.

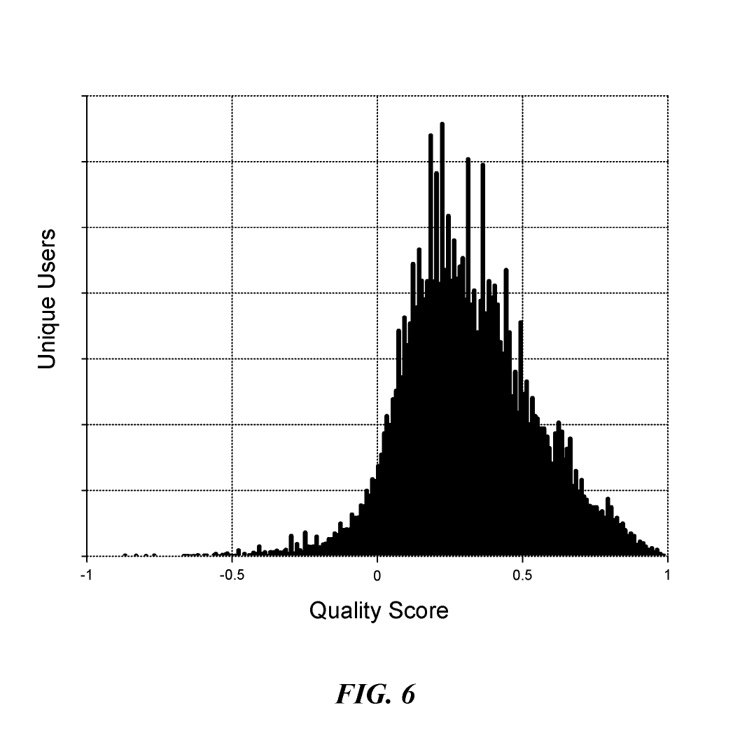

The System can then include this information in the Processed Data and report on it in various ways. For example, the system can report on this information to show a distribution of Quality Score over all or a segment of interactions, users or Categories. FIG. 6, for example, illustrates a distribution of Quality Scores for unique Users. As illustrated in the figure, Quality Score may range from −1 to 1, with a −1 representing the lowest quality interaction and a 1 representing the highest quality interaction. It will be appreciated, however, that other ranges of Quality Scores may be used.

As a further example, to report Quality Scores the system may show a time series of quality score for all or one or more segment of interactions, users or Categories. As a further example, the system may show a comparison of Quality Score at two or more different points in time and a delta between these. As a still further example, the system may show a comparison of Quality Score for two or more different segments or points in time and a delta between them and a decomposition of the factors contributing to the delta. In one example, Quality Score may be shown as going up, and the underlying factors are shown as being an increase in conversions, and a decrease in response time.

As a further example, Quality scores may be reported per agent in order to assess the performance of agents in responding to customer requests. As a further example the quality score may be reported per topic per agent so that the agents responding to topics that are more likely to be associated with lower quality scores (for example, “Refund>Defective merchandise”) are not unfairly handicapped as a result of the topics they are addressing. Similarly, agents who may be specifically seeking out interactions with users on more favorable topics would not receive an unfair advantage when the quality of their interactions is being assessed relative to peers. One of the benefit of the automatically generated quality score in examples such as these is that it can be applied across all customer interactions. In contrast, other sample-based approaches such as NPS cannot then be easily subsegmented, such as by agent and topic, due to small resulting sample sizes.

As a further example, the system may provide real time reporting on the Quality score for current natural language interactions. This may be used by users carrying out the interactions to decide where intervention is required (for example a manager of a team of customer service agents may view current Quality Score data in the system dashboard and decide to provide coaching to an agent whose current conversation is showing a low Quality Score). In this example, the system may display customer segment (for example high, medium, low value) along with Quality Score, so that managers may prioritize intervention for interactions where the user is both high value and the Quality Score is low.

### At Risk Score

To identify “at-risk” users who may be more likely to cancel their service or subscription, defect to a competitor, or complain publicly about a provider, a provider may want to use a single number, or At Risk Score, to describe the likelihood of a user to do one or both of these things.

One way such a score may be created is by analyzing the topics or step tags from natural language interactions in combination with structured data from a user account management system. For example, it may be found that users whose natural language interactions include the topic “Negative Product Feedback” are twice as likely to cancel their accounts in the 2 weeks following the interaction than those whose interactions include the topic “Where Is My Order,” and the At Risk Score computation could include corresponding weights of 2 and 1 for these topics respectively.

Another way such a score may be created is by analyzing the user sentiment of natural language interactions in combination with structured data from a user account management system. For example, it may be found that users whose natural language interactions have low user sentiment scores are twice as likely to cancel their accounts in the 2 weeks following the interaction than those whose interactions have neutral or positive user sentiment scores, and the At Risk Score computation could include corresponding weights of 2, 0 and 0 for these user sentiment buckets respectively.

The system can continuously refine the computation of At Risk Score by carrying out periodic statistical analysis on the raw natural language content of interactions, structured data derived from natural language interactions, and associated structured data from other systems along with the purchase or usage behavior of the user to create and update a model that can then be applied to all users to generate an At Risk Score.

The system can then include this information in the Processed Data and report on it in various ways. For example, the system can report on this information to show a distribution of At Risk Score over all or a segment of interactions, users or Categories, similar to that illustrated in FIG. 6 for Quality Score. As illustrated in the figure, At Risk Score may range from −1 to 1, with a −1 representing the lowest chance of undesired behavior (such as subscription cancellation, etc.) and a 1 representing the lowest probability. It will be appreciated, however, that other ranges of At Risk Scores may be used.

As a further example, to report At Risk Scores the system may show a time series of quality score for all or one or more segment of interactions, users or Categories. As a further example, the system may show a comparison of At Risk Score at two or more different points in time and a delta between these. As a still further example, the system may show a comparison of At Risk Score for two or more different segments or points in time and a delta between them and a decomposition of the factors contributing to the delta. In one example, At Risk Score may be shown as going up, and the underlying factors are shown as being an increase in problematic topics such as Negative Product Feedback, and a decrease in User Sentiment.

As a further example, At Risk Scores may be reported per agent in order to assess the performance of agents in responding to customer requests. As a further example, the quality score may be reported per topic per agent so that the agents responding to topics that are more likely to be associated with more at risk users (for example, “Refund>Defective merchandise”) are not unfairly handicapped as a result of the topics they are addressing. Similarly, agents who may be specifically seeking out interactions with users on more favorable topics would not receive an unfair advantage when the quality of their interactions is being assessed relative to peers. One of the benefit of the automatically generated At Risk score in examples such as these is that it can be applied across all customer interactions. In contrast, other sample-based approaches such as NPS cannot then be easily subsegmented, such as by agent and topic, due to small resulting sample sizes.

As a further example, the system may provide reporting on the number of interactions with all users whose At Risk score is above a specified threshold, aggregate statistics such as the lifetime value and projected lifetime value of these users, and the number of those users who went on to do the undesirable behavior segmented by different treatments of those users. Treatments may include different natural language responses (such as more or less profuse apologies, asking more or fewer clarifying questions), offering promotional pricing, free product or free shipping, or some post interaction actions such as sending an email or requesting the customer to complete a survey. Based on the results the provider may assess the return on investment of their interactions, and the relative effectiveness of different treatments of at risk users.

As a further example, the system may provide real time reporting on the at risk score for current natural language interactions. This may be used by users carrying out the interactions to decide the urgency with which resolution is required, the level of appeasement that may be required, or how apologetic to be. It may also be used to prioritize inbound natural language interactions for response (for example inbound emails or livechats). In this example, the system may display customer segment (for example high, medium, low value) along with At Risk Score, so that users may prioritize responding to interactions where the user is both high value and has a high At Risk score may be identified and prioritized first.

Prior approaches to solving this problem do not offer an automated and scalable way to categorize customers into categories of risk.

### Agent Assistant

A User (for example a customer service agent) may want immediate access to information that helps them more effectively carry out interactions with another Target User (for example a customer). The system provides this information via the Agent Assistant UI, the API or Plugins. The information provided may include any of the Processed Data.

In one example, the information may include demographic data, prior purchase behavior, referral source, Category Tags, Conversion Tags, Step Tags, Quality Scores from their prior interactions, or from all or parts of the currently active interaction.

In another example, the information provided may include recommendations on what products or services the Target User should consider purchasing based off information on the Target User as described in the preceding example, or actions a human agent should take to better meet a Target User's needs for example switching to an allergy-friendly service.

In another example, where the User's profile has been successfully joined across multiple clients, the information or the recommendations may be based off user data that has been aggregated across different clients' systems. For example, aggregated user data may include the user's purchase and natural language interaction history associated with various retailers.

In another example, and as described further herein regarding A/B testing, the recommendations may be the result of continuous testing carried out by the system based on the user information, and the prior performance of different message variants with similar Target Users in achieving specific business goals.

In another example, the information provided may include recommendations on tone of voice, or language to use. In another example, the information may include one or more recommended pre-composed messages. In another example, the information may include one or more promotional offers such as discounts. In another example, the information may include one or more recommended products or services. In another example, the information may be provided to a human operator or to a computer automated system.

### A/B Testing

A User may need to test different approaches to carrying out interactions, and see which is most effective at driving a defined business goal. As described herein, there may be several different variations a User may need to test. For example, a user may want to test various types of messaging content, different response times, or proactive outreach vs responding to inbound enquiries only. It will be appreciated that other interaction characteristics may be evaluated under a comparative A/B testing.

To facilitate A/B testing, the system first generates segments of users (e.g. customers) The system may generate these segments using various methods. For example, the system may automatically create random test and control groups of Target Users and inform the User (i.e., the user conducting the A/B testing) which group a particular Target User falls into in real time. As a further example, the User may decide which Target Users fall into which groups, and sends a segment identifier to the system as part of the Enrichment Data. As an additional example, the User decides which Target Users fall into which groups, and The System recognizes the groups based on the content of the messaging being used. As a still further example, the User decides which Target Users fall into which groups, and provides to The System a list of keywords or phrases being used in interactions that indicate a particular segment. The system then allows the User (i.e., the user conducting the A/B testing) to compare the effectiveness of different approaches by providing comparison reports to show performance by each segment in achieving the desired goals (for example maximizing ongoing purchases).

### Automated Messaging and Optimization

A User may need to automate messages to a Target User. As described herein, the system may send automated messages to the Target User in several ways. For example, the system may generate the automated messages in the same way as the recommendations described above, and send them via one or more Conversational Platforms. As an additional example, the system may provide the messages via API and/or a Plugin. As a further example, the system may send the messages directly to the Target User. As a still further example, the system may use Automated Messaging in conjunction with A/B Testing as described above to automatically test and optimize messaging.

### Illustrative Example of the System

Aspects of the system may be further illustrated with the following example. In this example, a retailer selling smartphone peripherals via SMS, website and native app, interacts with customers via a team of agents using conversation platforms (including SMS, on site livechat and in app livechat), for the purposes of increasing the number of customers who make purchases and/or the value of those purchases, and to resolve questions from customers may have about the products and services offered either before or after making a purchase.

### Ingesting & Normalizing

Natural language data from the Conversation platforms (SMS and chat platforms) is ingested via integrations with platforms used by the retailer. Commerce data including purchase data and product catalog data is ingested via integrations with the retailer's Commerce or CRM platforms. Digital analytics data is ingested via integrations with the retailer's analytics platform.

The system normalizes the Conversation data from different platforms into a common structure to allow for subsequent processing, grouping data into conversations, and storing conversation data. The system stores, for each conversation, the conversation ID, ID of the platform being used, the agent ID, customer ID, the natural language content of each interaction and the time stamps recording the timing of each part of the interaction as well as which user (e.g., agent or customer) generated each part. Where available it also ingests and stores the user ID (which may be a user email, user name, user address, order ID, or some combination of these), web or app usage data gathered by the platform, analytics sessions ID, and the results of any post interaction surveys collected.

Commerce data is also ingested, normalized and stored in a common format independent of the source platform. The stored commerce data may include a transaction ID, a user ID, timestamp, product IDs and quantities.

Web or mobile analytics data is also ingested, normalized and stored in a common format independent of the source platform. The stored analytics data includes a session ID, a user ID, timestamps, pages and events tracked. Examples of events may include checkout page views, adding item to cart, clicking to open a livechat window, etc.

### Joining Data Sets

By using user IDs, the system can join the disparate data sets. As described below, the system may employ different techniques to join the data set depending on, for example, the form of ingested user IDs.

For example, when the Conversation platforms capture the same format of user ID (for example, an email address) as the eCommerce system (for example, in the case the user is logged in) the user IDs are joined directly.

As a further example, when one or more Conversation platforms do not capture the same user ID as the Commerce platform (for example in the case the user is not logged in), but there is an analytics system in place which can be integrated with the commerce system and the conversation platform, the system joins the conversation platform user ID to the analytics user ID and the analytics ID to the commerce user ID, thereby joining the conversation platform user ID to the commerce user ID. In this example, the conversation platform and/or the analytics system can associate the same user to both the analytics ID and the conversation platform ID by a simple integration, and similarly the commerce system and the analytics system are able to associate the same user to both the analytics and the commerce user IDs by a second simple integration. Implementation of the analytics integrations with the conversation platform and the commerce platform is relatively trivial and may be carried out during set up of the system.

As an additional example, when the Conversation platforms do not capture the user ID in structured form (e.g., by integration with the website when users are logged in, or by requiring the user to enter their email address into a form prior to the beginning of their natural language interaction), the system may extract user specific data from the raw natural language itself. For example, the system may extract an email address, name, mailing address, or order number from the raw natural language data, and use this to match the user to data ingested from other systems such as Commerce or CRM data.

After data joining has been completed, the system can associate the purchase information ingested from the commerce platform with the natural language interaction data, and use the joined data in subsequent analysis.

### Generation of Metadata for Categorization, Conversation Steps and Satisfaction

As described herein, the System generates a randomly selected sample set of conversations, which are used to train models that can classify all or parts of all other conversations.

The system extracts data (“extracted data”) from each conversation or conversation part using Natural Language Processing. This extracted data includes the raw natural language strings, as well as derived keywords, phrases, word combinations (words appearing within a conversation or part of a conversation) and word sequences (series of words in a particular order, which may or may not be interspersed with other words). The extracted data also includes the relative position of these conversation parts, their absolute position within the conversation, the time elapsed between their appearance in the conversation, and whether they were input by a customer or a service representative.

The system identifies matches or near matches of extracted keywords and phrases with data from the product catalog provided via the Commerce platform integration (“matched data”).

The system then presents all or part of the extracted data and the matched data to a human operator who inspects the data visually, and inputs metadata for each step of each conversation (or the conversation overall) into the system. The operator may enter some or all of this data manually, but, where relevant, may also simply select some or all of the extracted interesting words and phrases as part of the input metadata.

For example, one conversation within the truth set may involve a customer who wants to buy a protective case for their smart phone, a ModelX by SmartPhoneInc. The extracted data includes the word “buy” 5 times, the word “case” 6 times, the word “SmartPhoneInc” 3 times, the word “ModelX” twice and the word “ModekX” once. The matched data includes the words “SmartPhoneInc” and “ModelX.” The system, as illustrated, matched the typo “ModekX” in the extracted data to the correct tag. The system presents this information along with the raw strings to the operator. The operator manually enters the metadata tag “purchase enquiry”, and selects the words “case” “SmartphoneInc” and “ModelX” as additional tags, all at the conversation level. In addition, the operator notes that the customer appears to be very happy with the level of service received during the conversation and marks the various conversation steps where this is apparent with the tag: high satisfaction.

During the process of reviewing more conversations in the truth set data, the operator recognizes that there are other conversations in the truth set where customers are looking to buy smartphone cases, and that these customers tend to follow a particular form with certain steps, namely Step 1: customer expresses intent to buy a case for their smart phone, Step 2: agent acknowledges request and asks for the customer's phone brand and model, Step 3: Customer provides phone brand and model Step 4: Agent provides list of suggested cases for the phone, Step 5: Customer thanks the agent and asks to purchase a particular case, Step 6: Agent asks for payment information, Step 7: Customer provides payment information, Step 8: Agent confirms purchase and provides order number. After recognizing this pattern, or indicators of progress with respect to a particular goal, the operator returns to this conversation and tags the steps in the conversation accordingly with metadata tags for each step. That is, the operator associates different parts of the conversation with the generally observed steps that occur as part of a purchase interaction.

As the operator adds metadata tags, the system stores these and makes them available to select so that the operator doesn't have to enter them manually, thereby reducing the time taken to apply the tags. After the operator has completed the task of entering metadata tags, the system divides the Truth Set into two parts—the Training Set and the Test Set.

The System then carries out a statistical analysis on the Training Set to correlate the extracted data and matched data with the metadata. For each metadata tag, the system assigns probabilities of a particular piece, class or combination of extracted data or matched data appearing in the same conversation or conversation part.

For example, the system, computes that a single appearance of the word “buy” means that the conversation falls into the category “purchase enquiry” with a probability of 50%, while if the word “buy” appears 5 times within a conversation, that probability increases to 95%. The system identifies that the appearance of the word combination “model name number please” in a conversation part entered by an agent means that the conversation part is Step 4 with a probability of 80%, while if the same combination entered by the agent is preceded by Step 1 this probability increases to 99%. The system identifies that the appearance of the words “thanks” and “awesome” in a conversation entered by the customer mean that the conversation is high satisfaction with a probability of 80%, and that where the data is available, the same words correlate with post interaction survey scores of very satisfied with s probability of 75%. The system generates many such rules and stores them as one or more conversational models for the retailer. As described above, the rules by which the system detects these probabilities may be generated, for example, based on operator evaluation of a sufficient number of training sets.

The system then applies the models to the Test Set and generates metadata tags for each conversation and conversation part. The system then compares the tags generated during this process with the tags generated by the operator. Based on the closeness of the match, the system adjusts the probability scores in the models and reapplies them. This process is repeated in an automated manner until a sufficiently high level of accuracy has been achieved.

If he system fails to achieve the desired level of accuracy for one or more tags, the system presents this information to an operator, including the tags, the current Truth Set and the model itself, for manual adjustment. The operator may adjust the items in the Truth set, or the weightings in the model, or may accept a lower level of accuracy, or may remove the model entirely. Once the models have been approved by the operator, the system applies them to the whole data set and generates metadata tags accordingly.

Since metadata tags are applied with a probability when metadata on a single conversation is required, a threshold probability is set for each metadata tag so that if the probability for a given tag for a given conversation is above the threshold ten the tag is assigned. In this example, there are no limits on the number of topics that may be assigned to any given conversation.

### Identifying and Measuring Post Conversation Funnel Progress and Affected Purchases

To determine how close to a purchase a customer got following a conversation, otherwise referred to as the progress measure of the interaction, the system joins conversation data with analytics data and commerce data as described above. Information on purchases may be derived from one or more of the commerce data, the analytics data, or the conversation data. The retailer then specifies in the system a lookback period to use in the analysis—for example the retailer may want to know how many sales took place within a lookback period of 1 day of a conversation taking place so that they can assess the impact of the conversations they are having via SMS as compared to livechat. The system computes all related conversations and transactions and generates affected sales data for reporting such as the total dollar amount of chat affected sales and SMS affected sales.

### Overall Quality Score

The retailer may wish to define high quality conversations as those that show good progress through defined steps, achieve a sale or other desirable outcome (conversion), or lead to high satisfaction. Based on these goals, the system assigns a topic-specific quality score to each conversation, which is a weighted average of satisfaction, % of steps achieved, and conversion. The weights can be configured automatically by the system or specified manually by the retailer.

An overall weighted average of these is computed (weighted by the volume of conversations). This quality score can be tracked over time, split by agent (to monitor agent performance), or by channel (to assess channel performance). When comparing quality score for two or more periods of time, agents, channels, or other segments, the system may additionally present the underlying factors that lead to any change in the score, to assist the retailer with diagnosis and determining the appropriate course of action.

### Testing Effectiveness of Natural Language Responses, and Optimization

The retailer may want to standardize certain responses or suggestions or steps in certain types of conversations, either by providing a response in an automated way or by providing a human agent with one or more recommended responses. For example, to increase the likelihood of a user providing their brand and model accurately in Step 2 described above. The system facilitates the testing of different responses, to see which ones perform best in achieving the desired outcomes. For example, an operator may be interested in testing an agent Response 1=“So that I can find products that best meet your needs, please tell me the brand and model of your phone” to a Response 2=“what phone do you have?”

To test effectiveness, a desired outcome (goal) must be defined—this may be a minimum conversation step reached (such as Step 3: User provides brand and model). Other examples of goals could be conversion (user purchases within 1 day lookback) or threshold level of satisfaction or overall quality score. Performance can be measured against more than one goal.

As conversations with customers are in progress, the System constructs test cells (groups of conversations) by randomly assigning a cell ID to each conversation as it commences, one cell for each of the different response approaches to be tested. The different cells receive different responses and the outcomes for each group are measured and compared. The retailer may find that Response 1 leads to 50% more Step 3s than Response 2, and then chose to implement Response 1 for all conversations going forward.

When carrying out automated responses, the system may automate the testing and optimization of different response approaches, whereby the system automatically generates responses to test, tests them as described above, identifies the best performing response and automatically begins to use that for all conversations going forward.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A computer-implemented method for deriving structured data from natural language interactions, the method comprising:
analyzing unstructured natural language data representing an interaction;
generating structured data representing the interaction based on mapping the unstructured natural language data to available sources of structured data,
wherein the mapping determines topics of interest mentioned during the interaction; and,
determining, based on the structured data representing the interaction, an interaction characterization,
wherein the interaction characterization represents a progress measure associated with a series of steps, a progress measure associated with resolving an issue, a progress measure associated with making a purchase, or a quality score of the interaction.

2. The method of claim 1, wherein at least one of the sources of structured data comprises a taxonomy of topics characterizing multiple natural language interactions.

3. The method of claim 1, wherein at least one of the sources of structured data comprises steps of an interaction associated with achieving a goal during a natural language interaction.

4. The method of claim 1, wherein the structured data characterizes a product preference of an individual associated with the interaction, and wherein the method further comprises generating a natural language response based on the product preference.

5. The method of claim 1, wherein the structured data comprises a topic of interest mentioned during the interaction, and wherein the method further comprises generating a targeted marketing message, based on the topic of interest, for a consumer associated with the interaction.

6. The method of claim 1, wherein the structured data comprises an at-risk score, wherein the at-risk score characterizes the likelihood that an individual will cancel a purchase or service.

7. The method of claim 1, further comprising generating, based on the structured data representing the interaction, a recommended response, and wherein a participant of the interaction is associated with a user profile comprising one or more of purchase history of the participant, interaction history of the participant, or participant preferences, and wherein the generation of the recommended response is based further on the user profile.

8. The method of claim 1 further comprising generating, based on the structured data representing the interaction, a recommended response, and wherein the recommended response is stored and made available to human agents or automated systems via various interfaces.

9. The method of claim 1, further comprising generating, based on the structured data representing the interaction, a recommended response.

10. A system configured to measuring the effectiveness of natural language interactions, the system comprising:
at least one physical processor;
at least one memory storing instructions which, when executed by the at least one processor, performs a method for:
defining one or more goals for interactions;
analyzing unstructured natural language data representing at least two interactions, wherein a first participant of the first interaction followed a first natural language script, and wherein a second participant of the second interaction followed a second natural language script;
generating first structured data representing the first interaction based on mapping the unstructured natural language data of the first interaction to available sources of structured data, wherein the first structured data indicates whether the goal was achieved;
generating second structured data representing the second interaction based on mapping the unstructured natural language data of the second interaction to available sources of structured data, wherein the second structured data indicates whether the goal was achieved; and
comparing the effectiveness of the first natural language script and the second natural language script based on the first structured data and the second structured data.

11. The system of claim 10, wherein the at least one memory further maintains structured data representing a plurality of interactions following the first natural language and the second natural language script, and wherein the compared effectiveness of the first natural language script and the second natural language script is based further on the maintained structured data.

12. The system of claim 10, wherein the at least one memory further stores instructions which, when executed by the at least one processor, performs the method further comprising generating a recommended response based on the compared effectiveness, and wherein the recommended response is delivered by an automated system.

13. The system of claim 10, wherein the at least one memory further stores instructions which, when executed by the at least one processor, performs the method further comprising generating a recommended response based on the compared effectiveness, and wherein the recommended response is delivered by a human.

14. The system of claim 10, wherein the at least one memory further stores instructions which, when executed by the at least one processor, performs the method further comprising generating a recommended response based on the compared effectiveness.

15. A non-transitory computer-readable medium comprising instructions configured to cause one or more processors to perform a method for generating structured interaction data for an individual, the method comprising:
receiving a plurality of data sets characterizing natural language interactions;
identifying, from the plurality of data sets, data characterizing different natural language interactions with the same individual; and
joining the data to generate structured interaction data for the individual,
wherein the structured interaction data comprises natural language interaction data from one or more sources, consumer purchase history data, digital analytics data, offline purchase data, or data from marketing systems such as Customer Relationship Management or Helpdesk systems.

16. The non-transitory computer-readable medium of claim 15, further comprising evaluating the structured interaction data for the individual to generate an at-risk score associated with the individual, wherein the at-risk score is generated based on one or more of topic tags, user sentiment bucket, purchase behavior, or keywords.

17. The non-transitory computer-readable medium of claim 15, further comprising evaluating the structured interaction data for the individual to generate a quality score associated with one or more of the natural language interactions, wherein the quality score is generated based on a statistical model evaluation of interaction steps, NPS score, interaction survey results, or goal conversions associated with the one or more natural language interactions.

18. The non-transitory computer-readable medium of claim 15, further comprising evaluating the structured interaction data for the individual to measure the effectiveness of a natural language interaction against a defined goal, wherein measuring the effectiveness of the natural language interaction against the defined goal comprises:
identifying a desired outcome and one or more steps associated with the defined goal;
determining, from the structured interaction data, an agent response corresponding to each of at least one of the one or more steps;
evaluating the effectiveness of the at least one agent response towards achieving the desired outcome; and
determining the effectiveness of the natural language interaction based on the effectiveness of the at least one agent response.

19. The non-transitory computer-readable medium of claim 15, wherein the structured interaction data for the individual characterizes a product preference of the individual, and wherein the method further comprises generating a natural language response based on the product preference.

20. The non-transitory computer-readable medium of claim 15, wherein the structured interaction data for the individual comprises a topic of interest mentioned during a natural language interaction, and wherein the method further comprises generating a targeted marketing message, based on the topic of interest, for the individual.
